(19) United States
(12) Patent Application Publication
(10) Pub. No.: US 2002/0167520 A1
(43) Pub. Date: Nov. 14, 2002

(54) Memory usage minimization method for a CAD system

(76) Inventor: I-Jen Su, HsinChu City (TW)

Correspondence Address: BIRCH STEWART KOLASCH & BIRCH, PO BOX 747, FALLS CHURCH, VA, 22040-0747, US

(21) Appl. No.: 09/852,714

(22) Filed: May 11, 2001

(51) Int. Cl. G06T 11/20

(52) U.S. Cl. 345/441

(57) ABSTRACT

A memory usage minimization method for a CAD system is characterized in that a reference point, a first vector, and a second vector are used to represent the graph data of an L-shape polygon formed from a first rectangle and a second rectangle.

### BACKGROUND OF THE INVENTION

1. Field of Invention

The invention relates to a memory usage minimization method for a CAD system and, in particular, to a memory usage minimization method for a CAD system that can efficiently compress CAD data to minimize the memory occupied by the CAD data.

2. Related Art

In semiconductor technologies, CAD systems are often used to design ICs (integrated circuit) and mask patterns. CAD data are usually many repeated patterns, which are rectangular or L-shape polygons.

For example, as shown in FIG. 1, an L-shape polygon 10 is defined by the coordinates of six points, point 101 through point 106. The data amount of the L-shape polygon 10 can be expressed by the following equation:

(4+4)×6=48 (bytes). (1)

Therefore, the data amount is 48 bytes.

However, as semiconductor devices are miniaturized, the layout of ICs and mask patterns become more complicated, resulting into increasing CAD data (maybe several GB). Under this situation, one set of CAD data are usually completed by several IC design engineer. The files of the CAD data are then stored in the HDD (Hard Disk Drive) of a network server so that the IC design engineers can share and modify the CAD data through the network.

Since the amount of the CAD data is huge, transmitting them on a network must occupy a lot of time and bandwidth of the network. Therefore, how to decrease the CAD data amount to minimize memory usage and network transmission time has become an important subject.

### SUMMARY OF THE INVENTION

An object of the invention is to provide a memory usage minimization method for a CAD system by using fewer data to represent an L-shape polygon to decrease the CAD data.

As described, the invention is featured in employing fewer data to represent the coordinate data of the six points of an L-shape polygon.

To achieve the above object, the invention provides a memory usage minimization method for a CAD system, which uses a reference point, a first vector, and a second vector to represent the graph data of an L-shape polygon, composed of a first rectangle and a second rectangle.

According to a first aspect of the invention, the first rectangle and the second rectangle are combined by overlapping on one side and one corner. The outer border after the combination has an L shape. The overlapped corner is at the end point of the first vector and the initial point of the second vector. The initial point of the first vector is at the point diagonally opposite to the overlapped corner in the first rectangle. The end point of the second vector is at the point diagonally opposite to the overlapped corner in the second rectangle. The reference point is at the initial point of the first vector.

According to a second aspect of the invention, the first rectangle and the second rectangle are combined by overlapping one side and one corner. The outer border after the combination has an L shape. The overlapped side in the first rectangle is longer than the overlapped side in the second rectangle. Thus, one end of the overlapped side in the first rectangle does not overlap with any corner of the second rectangle. This end is at the end point of the first vector and the initial point of the second vector. The initial point of the first vector is at the point diagonally opposite to the end point in the first rectangle. The end point of the second vector is at the point diagonally opposite to the overlapped corner in the second rectangle. The reference point is at the initial point of the first vector.

According to a third aspect of the invention, the first rectangle and the second rectangle are combined by overlapping two sides and one corner. The overlapped sides in the first rectangle are longer than the overlapped sides in the second rectangle, respectively. The inner border of the combined graph has an L shape. The overlapped corner is at the end point of the first vector and the initial point of the second vector. The initial point of the first vector is at the point diagonally opposite to the overlapped corner in the first rectangle. The end point of the second vector is at the point diagonally opposite to the overlapped corner in the second rectangle. The reference point is at the initial point of the first vector.

According to a fourth aspect of the invention, the first rectangle and the second rectangle are combined by overlapping two sides and one corner. The overlapped sides in the first rectangle are shorter than the overlapped sides in the second rectangle, respectively. The inner border of the combined graph has an L shape. The overlapped corner is at the initial point of the first vector and the end point of the second vector. The end point of the first vector is at the point diagonally opposite to the overlapped corner in the first rectangle. The initial point of the second vector is at the point diagonally opposite to the overlapped corner in the second rectangle. The reference point is at the end point of the first vector.

Since the disclosed memory usage minimization method for a CAD system uses one point and two vectors to represent graph data of an L-shape polygon, thus fewer data are needed to represent the L-shape polygon. This achieves the goal of reducing the CAD data amount, minimizing memory usage and network transmission time.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view showing the data of an L-shape polygon in the prior art;

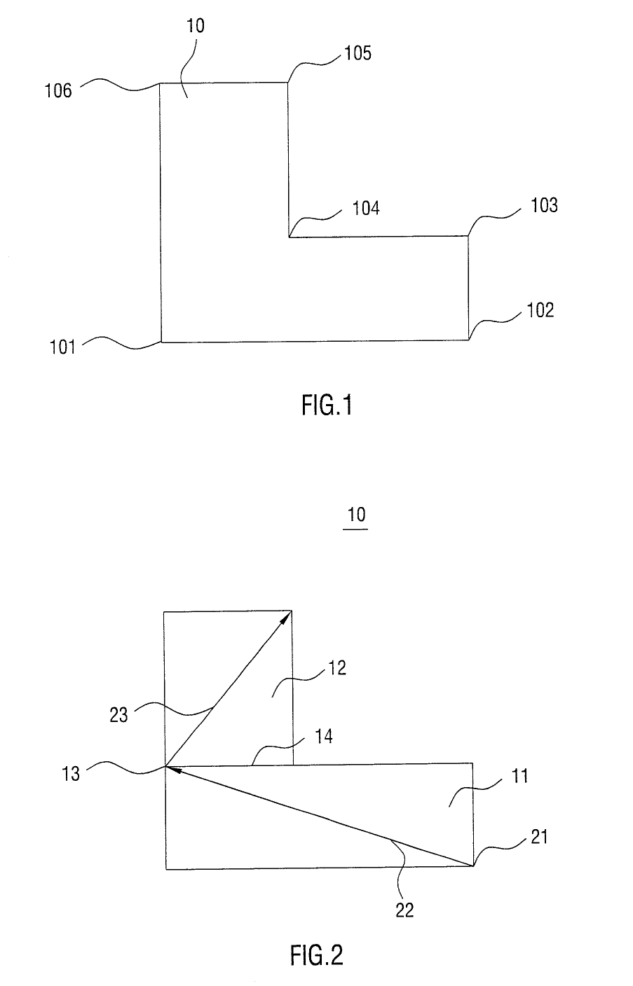

FIGS. 2 through 5 are schematic views showing preferred embodiments of the disclosed memory usage minimization method for a CAD system of the invention; and

FIG. 6 is a schematic view showing another possible structure of an L-shape polygon.

### DETAILED DESCRIPTION OF THE INVENTION

The memory usage minimization method for a CAD system of the invention will be apparent from the following detailed description, which proceeds with reference to the accompanying drawings, wherein the same references relate to the same elements.

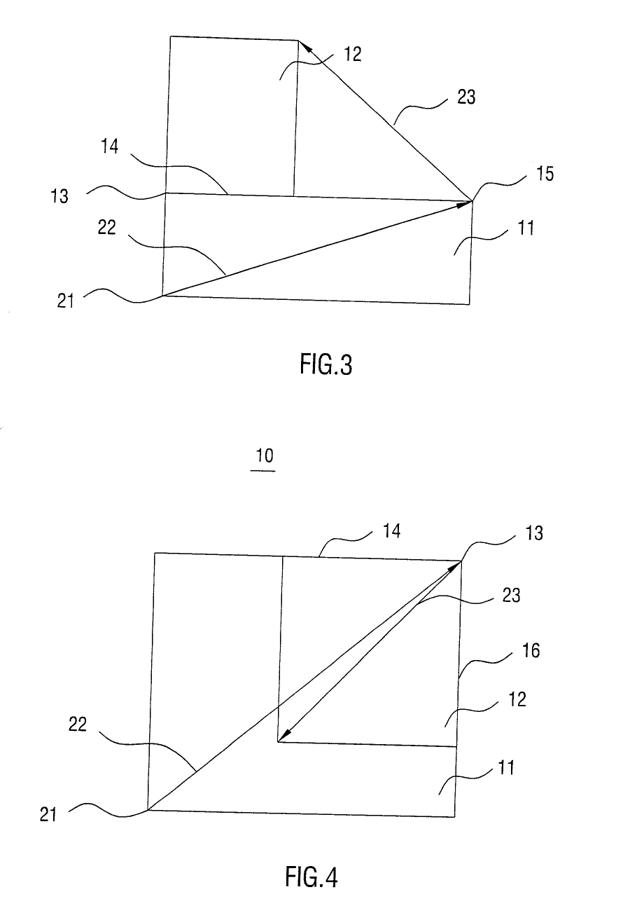

As shown in FIGS. 2 through 5, a preferred embodiment of the disclosed memory usage minimization method for a CAD system uses a reference point 21, a first vector 22 and a second vector 23 to represent a first rectangle 11 and a second rectangle 12, which combine to form the graph data of an L-shape polygon 10. The data amount for the L-shape polygon is:

(4+4)+(2+2)×2=16 (bytes). (2)

So the data amount for the L-shape polygon 10 decreases from 48 bytes in the prior art to 16 bytes. The memory usage is reduced by 66.7%.

For the embodiment shown in FIG. 2, the first rectangle 11 and the second rectangle 12 are combined together by overlapping one corner 13 and one side 14. The outer border of the combined graph of the first rectangle 11 and the second rectangle 12 has an L shape. The overlapped corner 13 is at the end point of the first vector 22 and the initial point of the second vector 23. The initial point of the first vector 22 is at the point diagonally opposite to the overlapped corner 13 in the first rectangle 11. The end point of the second vector 23 is at the point diagonally opposite to the overlapped corner 13 in the second rectangle 12. The reference point 21 is at the initial point of the first vector 22. The reference point 21 along with the first vector 22 can represent the data of the four corners of the first rectangle 11, including the overlapped corner 13. The overlapped corner 13 and the second vector 23 can represent the data of the four corners of the second rectangle 12. Therefore, the reference point 21, the first vector 22 and the second vector 23 together can represent the data of the 6 points of the L-shape polygon 10.

With reference to another embodiment shown in FIG. 3, the first rectangle 11 and the second rectangle 12 are combined by overlapping one side 14 and one corner 13. The outer border of the combined graph has an L shape. The overlapped side in the first rectangle 11 is longer than the overlapped side in the second rectangle 12. Thus, one end 15 of the overlapped side in the first rectangle ll does not overlap with any corner in the second rectangle 12. This end 15 is at the end point of the first vector 22 and the initial point of the second vector 23. The initial point of the first vector 22 is at the point diagonally opposite to the end point 15 in the first rectangle 11. The end point of the second vector 23 is at the point diagonally opposite to the end 15 in the second rectangle 12. The reference point 21 is at the initial point of the first vector 22. The reference point 21 and the first vector 22 can represent the data of the four corners of the first rectangle 11, including the overlapped corner 13 and the end 15. The second vector 23, the end 15 and the overlapped point 13 can represent the data of the four corners of the second rectangle 12. Therefore, the reference point 21, the first vector 22 and the second vector 23 can represent the data of the 6 corners of the L-shape polygon 10.

With reference to a third embodiment shown in FIG. 4, the first rectangle 11 and the second rectangle 12 are combined by overlapping two sides 14, 16 and one corner 13. The overlapped sides in the first rectangle 11 are greater than the overlapped sides in the second rectangle 12, respectively. The inner border of the combined graph has an L shape. The overlapped corner 13 is at the end point of the first vector 22 and the initial point of the second vector 23. The initial point of the first vector 22 is at the point diagonally opposite to the overlapped corner 13 in the first rectangle 11. The end point of the second vector 23 is at the point diagonally opposite to the overlapped corner 13 in the second rectangle 12. The reference point 21 is at the initial point of the first vector 22. The reference point 21 and the first vector 22 can represent the data of the four corners of the first rectangle 11, including the overlapped corner 13. The second vector 22 and the overlapped corner 13 can represent the data of the four corners of the second rectangle 23. Therefore, the reference point 21, the first vector 22, and the second vector 23 can represent the data of the 6 corners of the L-shape polygon 10.

A fourth embodiment is shown in FIG. 5. The first rectangle 11 and the second rectangle 12 are combined by overlapping two sides 14, 16 and one corner 13. The overlapped sides in the first rectangle 11 are shorter than the overlapped sides in the second rectangle 12, respectively. The inner border of the combined graph has an L shape. The overlapped corner 13 is at the initial point of the first vector 22 and the end point of the second vector 23. The end point of the first vector 22 is at the point diagonally opposite to the overlapped corner 13 in the first rectangle 11. The initial point of the second vector 23 is at the point diagonally opposite to the overlapped corner 13 in the second rectangle 12. The reference point 21 is at the initial point of the first vector 11. The reference point 21 and the first vector 22 can represent the data of the four corners of the first rectangle 11, including the overlapped point 13. The second vector 23 and the overlapped point 13 can represent the data of the four corners of the second rectangle 12. Therefore, the reference point 21, the first vector 22, and the second vector 23 can represent the data of the 6 corners of the L-shape polygon 10.

In the invention, when the Quad-Tree Structure method is used to partition the CAD data, the data of the reference point 21 can be represented by a reference vector whose end point is the reference point 21. The initial point of the reference vector is a quad-tree node generated when partitioning the CAD data using the Quad-Tree Structure method. The data amount for the L-shape polygon 10 can be expressed by:

(2+2)+(2+2)×2=12 (bytes). (3)

The result is that the data amount for the L-shape polygon 10 decreased from 48 bytes in the prior art to 12 bytes. So the memory usage is reduced by 75%. The Quad-Tree Structure method to generate the quad-tree mode is a technique well known to people skilled in the art and thus will not be repeated herein.

When using an array to store the data of the reference point 21, the first vector 22, and the second vector 23, the disclosed method may further compresses the data to minimize the memory usage. It is able to reduce 50% of the memory usage. Thus, the data amount for the L-shape polygon is, according to Eq. (3):

12×50%=6 (bytes) (4)

The net result is that the data amount of the L-shape polygon 10 goes from 48 bytes down to 6 bytes. The memory usage reduces 87.5%. The method of storing the data of the reference point 21, the first vector 22 and the second vector 23 in an array is well known to skilled persons and is not repeated herein.

In conclusion, the preferred embodiments disclosed herein for the memory usage minimization method for a CAD system of the invention uses a reference point, a first vector, and a second vector to represent the data of an L-shape polygon. Therefore, fewer data are needed to represent the L-shape polygon. This then achieves the goal of reducing CAD data, further minimizing memory usage and network transmission time.

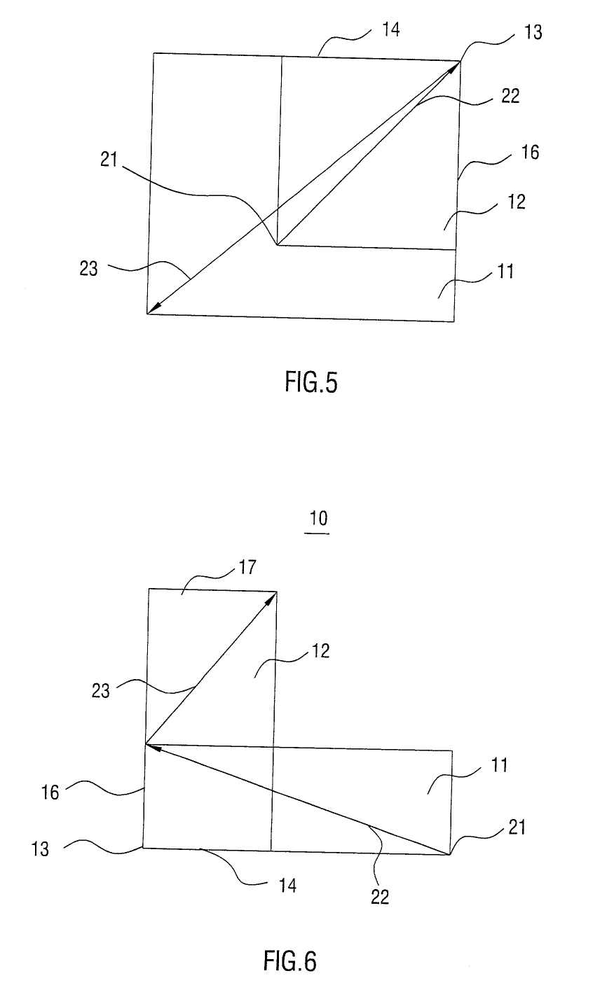

Any person skilled in the art can make equivalent modifications of the disclosed embodiments without departing from the spirit and scope of the invention. For example, as shown in FIG. 6, the first rectangle 11 and the second rectangle 12 are combined by overlapping one corner 13 and two sides 14, 16. One of the overlapped sides in the first rectangle 11 is shorter than one of the overlapped sides in the second rectangle 12, whereas the other overlapped side in the first rectangle 11 is longer than the other overlapped side in the second rectangle 12. The outer border of the combined graph (union) of the first rectangle 11 and the second rectangle 12 has an L shape. A third rectangle 17 can be obtained by subtracting the intersection of the first rectangle 11 and the second rectangle 12 from the second rectangle 12. The result is that the first rectangle 11 and the third rectangle 17 look exactly the same as the first embodiment and the second embodiment disclosed herein. Therefore, one only needs a reference point 21, a first vector 22 and a second vector to represent the graph data for an L-shape polygon. The preferred embodiments used in the description should not be construed in a limiting sense. It is, therefore, contemplated that the appended claims will cover all modifications that fall within the true scope of the invention.

What is claimed is:

1. A memory usage minimization method for a CAD system, which is characterized in that a reference point, a first vector, and a second vector are used to represent the graph data of an L-shape polygon formed from a first rectangle and a second rectangle.

2. The method of claim 1, wherein
the first rectangle and the second rectangle are combined by overlapping on one side and one corner so that the outer border of the combined graph has an L shape;
the end point of the first vector is at the overlapped corner;
the initial point of the second vector is at the overlapped corner;
the initial point of the first vector is at the point diagonally opposite to the overlapped corner in the first rectangle;
the end point of the second vector is at the point diagonally opposite to the overlapped corner in the second rectangle; and
the reference point is at the initial point of the first vector.

3. The method of claim 1, wherein
the first rectangle and the second rectangle are combined by overlapping one side and one corner so that the outer border of the combined graph has an L shape;
the overlapped side in the first rectangle is longer than the overlapped side in the second rectangle;
the end point of the first vector is one end of the overlapped side in the first rectangle does not overlap with any corner of the second rectangle;
the initial point of the second vector is at the end of the overlapped side in the first rectangle does not overlap with any corner in the second rectangle;
the initial point of the first vector is at the point diagonally opposite to the end of the overlapped side in the first rectangle;
the end point of the second vector is at the point diagonally opposite to the overlapped corner in the second rectangle; and
the reference point is at the end point of the first vector.

4. The method of claim 1, wherein
the first rectangle and the second rectangle are combined by overlapping two sides and one corner;
the overlapped sides in the first rectangle are longer than the overlapped sides in the second rectangle, respectively;
the inner border of the combined graph has an L shape;
the end point of the first vector is at the overlapped corner;
the initial point of the second vector is at the overlapped corner;
the initial point of the first vector is at the point diagonally opposite to the overlapped corner in the first rectangle;
the end point of the second vector is at the point diagonally opposite to the overlapped corner in the second rectangle; and
the reference point is at the end point of the first vector.

5. The method of claim 1, wherein
the first rectangle and the second rectangle are combined by overlapping two sides and one corner;
the overlapped sides in the first rectangle are shorter than the overlapped sides in the second rectangle, respectively;
the inner border of the combined graph has an L shape;
the initial point of the first vector is at the overlapped corner;
the end point of the second vector is at the overlapped corner;
the end point of the first vector is at the point diagonally opposite to the overlapped corner in the first rectangle;
the initial point of the second vector is at the point diagonally opposite to the overlapped corner in the second rectangle; and
the reference point is at the initial point of the first vector.

6. The method of claim 1, wherein the reference point is represented by a reference vector having an end point at the reference point and an initial point at a quad-tree node.

7. The method of claim 1, wherein the data of the reference point, the first vector, and the second vector are stored in an array.
